(19) United States
(12) Patent Application Publication
(10) Pub. No.: US 2002/0063440 A1
(43) Pub. Date: May 30, 2002

(54) VEHICLE INCLUDING A DOOR

(76) Inventors: Nigel Victor Spurr, Birmingham (GB); Gurbinder S. Kalsi, Oldbury (GB); Richard Watson, Southam (GB); Andrew J. Fairey, Aldridge (GB); Gregory Keyes, Birmingham (GB); Axel Fauveau, Tamworth (GB); Sidney Fisher, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 09/843,264

(22) Filed: Apr. 25, 2001

(30) Foreign Application Priority Data
Apr. 25, 2000 (GB) GB0009795.6

(51) Int. Cl. B60J 10/08

(52) U.S. Cl. 296/146.9; 296/202

(57) ABSTRACT

A passenger door having a self engaging latch for latching the door in a closed position, the door further including a plurality of fixing bolts positioned about the periphery of the door to further secure the door in a closed position.

### BACKGROUND OF THE INVENTION

The present invention relates to a vehicle including a door, and in particular to cars including doors.

Car passenger doors are currently provided with a latch situated midway up the rear side of the door. When the door is closed, the latch engages with a striker positioned on the door post (such as an A post, a B post or a C post) such that the door is fixed in a closed position. The latch can be released from the striker by operation of an inside door handle or an outside door handle.

Moreover cars are known which have a specifically designed front and rear crumpled zones to absorb a substantial amount of an impact to the car body. A passenger, which term is to be understood as including a driver, in the car is protected from the accident by a rigid safety cell formed by the passenger compartment. The strength of the safety cell is very much dependant on the doors remaining in their closed position when an impact occurs, either to the side or to either end of the car.

During road traffic accidents the doors of vehicles have been known to open or at least partially open thereby reducing the strength of the safety cell and endangering the safety of the passengers.

### SUMMARY OF THE INVENTION

An object of the present invention is to provide a passenger door which is less likely to open or partially open during an impact.

Thus according to the present invention there is provided a vehicle including a passenger door for substantially closing a door aperture of the vehicle, the vehicle including a self engaging latch assembly comprising a latch mounted on one of the door or door aperture and a striker mounted on the other of the door or door aperture for latching the door in a closed position, the vehicle further including a plurality of fixings bolts positioned around the periphery of one of the door or door aperture to engage respective abutments positioned around the periphery of the other of the door or door aperture to further secure the door in a closed position.

### BRIEF DESCRIPTION OF THE DRAWINGS

An embodiment of the present invention will now be described, by way of example only, with reference to the accompanying drawings in which:

FIG. 1 is a partial schematic side view of a vehicle according to the present invention incorporating a passenger door according to the present invention.

FIG. 2 is a view of a latch assembly of FIG. 1 taken in the direction of arrow A.

FIG. 3 is a view of bolt arrangement of FIG. 1.

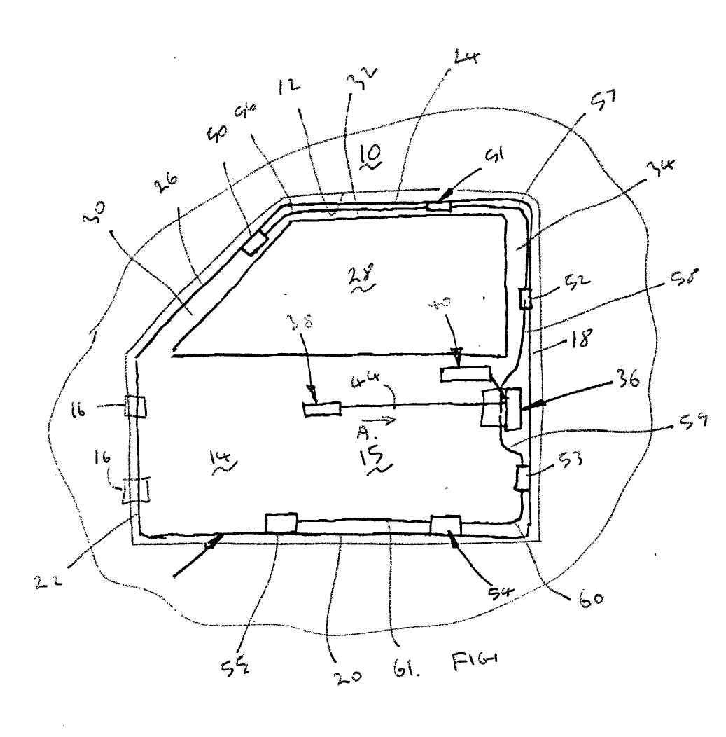

### DETAILED DESCRIPTION OF THE PREFERRED EMBODIMENT

With reference to the figures there is shown a vehicle 10 having a door aperture 12 which is substantially closed by a door 14. Door aperture 12 is defined by fixed structure of the vehicle, in this case an A post, a door sill, a B post, a roof edge and a windscreen pillar. Door 14 is pivotally mounted at a front portion by hinges 16 to the vehicle 10 the door includes a substantially vertical opening edge 18 (in this case a rear edge) a substantially horizontal lower edge 20, a hinged edge 22 (in this case a front hinged edge), a substantially horizontal upper edge 24, and an angled edge 26, the angle of which is substantially determined by the angle of a windscreen (not shown) of the vehicle.

The door further includes a window aperture 28 being bounded at a lower edge by a body portion 15 of door 14 and at a front upper and rear portion by a front window rim 30, and upper window rim 32, and a rear window rim 34 respectively. The door includes a self engaging latch 36 having a rotating claw of conventional type engagable with a door mounted striker also of known type to secure the door in a closed position.

Inside handle 38 and outside handle 40 are manually actuatable to open the latch 36.

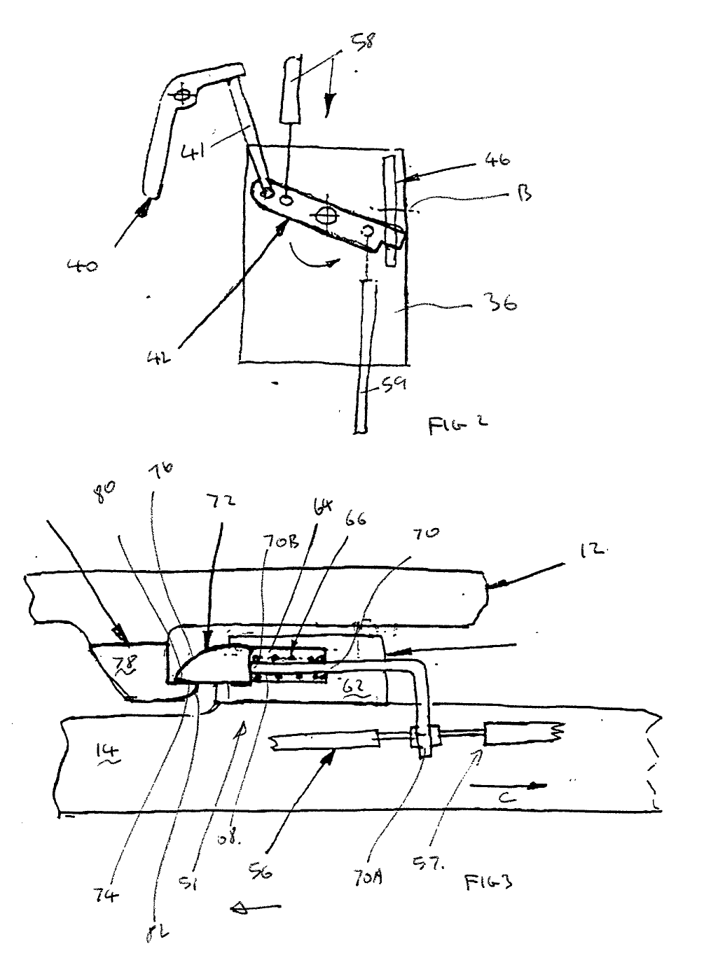

In this case outside handle 40 operates via rod 41 to rotate the release lever 42 of latch 36 in an anticlockwise direction as shown in FIG. 2. Furthermore inside handle 38 acts via rod 44 and crank lever 46 (which is pivotable about axis B) to also rotate the release lever 42 in an anticlockwise direction when viewing FIG. 2.

The door further includes a plurality of bolt assemblies 50, 51, 52, 53, 54 and 55 each positioned around the periphery of the door. The bolt assemblies 50, 51, 52, 53, 54 and 55 are connected to the release lever 42 by bowden cables 56, 57, 58, 59, 60 and 61.

With reference to FIG. 3 there is shown bolt assembly 51 and bowden cables 56 and 57. Bolt assembly 51 comprises a housing 62 mounted on the door 14 and having a recess 64 in which is mounted spring 66 and bolt 68. Bolt 68 includes a stem portion 70 being bent at 90 degrees and having an end 78 for engagement with bowden cables 56 and 57. Stem 70 is slidable within housing 62.

Attached to end 70B of stem 70 is an engagement portion 72 having engagement face 74 and a camming surface 76.

The door aperture 12 includes a striker 78 having an engagement surface 80 and a camming surface 82.

With the door in the position as shown in FIG. 3 operation of the inside or outside door handle causes the release lever 42 to rotate in an anticlockwise direction when viewing FIG. 2 thus pulling on bowden cable 58. Bowden cable 58 is connected to bowden cable 57 at the bolt assembly 52. Thus bowden cable 57 is caused to move in the direction of arrow C of FIG. 3, causing the bolt 68 to also move in the direction of arrow C of FIG. 3. Such action disengages the engagement faces 74 and 80 thus allowing the door to open.

Release of the inside or outside door handle allows the bolt to return to the position as shown as FIG. 3 (albeit with the door in an open position).

When the door is closed the camming surfaces 82 and 76 cause the bolt 68 to move in the direction of arrow C until such time as engagement portion 72 moves past engagement surface 80 whereupon spring 66 biases the bolt 68 in the direction of arrow D of FIG. 3 causing the engagement surfaces 74 and 80 and re-engage.

All bolt assemblies are substantially similar.

It will be appreciated that bolt assemblies 50 and 55 are only connected to a single bowden cable since they are at the terminus of a series of bowden cables.

It will be appreciated that bolt assemblies 50, 51, 52, 53, 54 and 55 are all self engaging bolt assemblies. In further embodiments it is possible to have bolts which do not self engage but which can for example engage upon actuation of locking of the door.

It will also be appreciated that in further embodiment bowden cables 56, 57 and 58 can be replaced by a single bowden cable with appropriate connections being made to this cable by the bolts. Similarly bowden cables 59, 60 and 61 can be replaced by a single bowden cable.

It will apparent that whilst the bolts have been described has being mounted on the door and engaging strikers mounted on an associated door aperture, it is also possible to mount the self engaging latch and bolts on the door aperture and provide appropriate strikers for the self engaging latch and bolts on the door, with each striker being adjacent its corresponding latch/bolt when the door is in a closed position.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A vehicle including a passenger door for substantially closing a door aperture of the vehicle, the vehicle including a self engaging latch assembly comprising a latch mounted on one of the door and the door aperture and a striker mounted on the other of the door and the door aperture for latching the door in a closed position, the vehicle further including a plurality of fixings bolts positioned around a periphery of one of the door and the door aperture to engage respective abutments positioned around a periphery of the other of the door and the door aperture to further secure the door in the closed position.

2. The vehicle as defined in claim 1 in which at least one of the plurality of fixing bolts is a self engaging fixing bolt.

3. The vehicle as defined in claim 1 in which at least one of the plurality of fixing bolts is a non self engaging fixing bolt and which engages upon locking of the door.

4. The vehicle as defined in claim 1 in which the self engaging latch assembly is positioned substantially midway up a substantially vertical opening edge of the door.

5. The vehicle as defined in claim 1 in which at least one of the plurality of fixing bolts is positioned at or adjacent an upper portion of a substantially vertical opening edge of the door.

6. The vehicle as defined in claim 1 in which at least one of the plurality of fixing bolts is positioned at or adjacent a lower portion of a substantially vertical opening edge of the door.

7. The vehicle as defined in claim 1 in which at least one of the plurality of fixing bolts is positioned at or adjacent a lower edge of the door.

8. The vehicle as defined in claim 7 in which at least one of the plurality of fixing bolts positioned at or adjacent the lower edge of the door is positioned proximal a corner defined by the confluence of the lower edge of the door with a substantially vertical opening edge of the door.

9. The vehicle as defined in claim 7 in which the at least one of the plurality of fixing bolts positioned at or adjacent the lower edge of the door is positioned proximal to hinges of the door.

10. The vehicle as defined in claim 1 in which at least one of the plurality of fixing bolts is positioned at or adjacent an upper edge of the door.

11. The vehicle as defined in claim 1 in which at least one of the plurality of fixing bolts is positioned at or adjacent an angled edge of the door, the angle being substantially defined by a windscreen of an associated vehicle.
